(19) United States
(12) Patent Application Publication
(10) Pub. No.: US 2011/0230286 A1
(43) Pub. Date: Sep. 22, 2011

(54) Variable Drive Transmission

(76) Inventor: Eli Cohen, Lincoln Park, NJ (US)

(21) Appl. No.: 12/826,651

(22) Filed: Jun. 29, 2010

Related U.S. Application Data
(60) Provisional application No. 61/314,906, filed on Mar. 17, 2010.

(51) Int. Cl. F16H 7/12

(52) U.S. Cl. 474/49

(57) ABSTRACT

A variable drive transmission system is provided that includes at least one variable diameter gear coupled to a drive shaft at a hub of the variable diameter gear, the drive shaft provides a driving force that causes rotational movement in the first variable diameter gear. The variable diameter gear includes a spiral spring component that extends out of the hub of the first gear, coils spirally in a direction around the hub, and terminates openly on an outer surface of the variable diameter gear. The application of the driving force at the hub causes the spiral spring component to one of wind and unwind and as a result increase or decrease the diameter of the first variable diameter.

### BACKGROUND OF THE INVENTION

The present application claims priority to U.S. Provisional Patent Application No. 61/314,906, which was filed Mar. 17, 2010 and which is incorporated herein by reference.

The present application relates to a variable drives transmission system and more particularly a variable drive transmission with torque damping characteristics.

A number of variable drive transmission systems with and without damping characteristics have been proposed, such as those discussed in U.S. Pat. Nos. 551,867; 1,374,797; 2,908,356; 3,894,615; 3,956,944; 4,103,516; 4,108,459; 4,305,599; 4,416,464; 4,741,546; 4,990,123; and 6,053,830, each of which are incorporated herein by reference. Each of these systems, however, has significant drawbacks, such as complex designs that are costly to produce. Accordingly, there is a need for variable drive systems that are less complex and thereby less costly to produce.

### SUMMARY OF THE INVENTION

In one embodiment, a variable drive transmission system is provided that includes a first variable diameter gear coupled to a drive shaft at a hub of the first variable diameter gear, the drive shaft provides a driving force that causes rotational movement in the first variable diameter gear. In this instance, the first variable diameter gear includes a spiral spring component that extends out of the hub of the first gear, coils spirally in a direction around the hub, and terminates openly on an outer surface of the variable diameter gear. The application of the driving force at the hub causes the spiral spring component to one of wind and unwind and as a result increase or decrease the diameter of the first variable diameter, The transmission further includes a second gear having an outer surface, a continuous belt that is located over the outer surfaces of the first and the second gears and that is held in tension over the outer surfaces of the gears to transfer rotational movement from first gear to the second gear, and a tensioner that applies a force onto the continuous belt to maintain the belt tension.

In one embodiment, the direction of the spiral spring is one of clockwise and counter clockwise.

In one embodiment, the second gear is a variable diameter gear coupled to a drive shaft at a hub of the second variable diameter gear and it includes a spiral spring component that extends out of the hub of the second gear, coils spirally in a direction around the hub, and terminates openly on an outer surface of the variable diameter gear. Application of the driving force generally causes the spiral spring component to one of wind and unwind, and as a result increase or decrease the diameter of the second variable diameter gear.

In one embodiment, the spring of the first gear is wound in a first direction and the spring of the second gear is wound in a second direction opposite the first direction. In this instance, the application of a driving force causes one of the gears to increase in diameter and another gear to decrease in diameter.

In one embodiment, the first direction of the spring in the first gear causes the diameter of the first gear to decrease with the application of the driving force on the first gear and the second direction of the spring in the second gear causes the diameter of the second gear to increase with the application of the driving force on the second gear.

In one embodiment, the first variable diameter gear includes teeth that engage corresponding teeth on the belt.

In one embodiment, the teeth start at the opening on the outer surface of the first variable diameter gear and continue around less than all of the circumference of the outer surface of the first variable diameter belt.

In one embodiment, the spring has a response characteristic tailored to one of a specific rider type and a specific riding condition.

In one embodiment, a spring for a heavier rider has a response characteristic different than a spring for a lighter rider.

In one embodiment, the spring has at least one variable characteristic to provide a variable response.

### BRIEF DESCRIPTION OF THE FIGURES

FIG. 1 is a perspective view of a variable drive transmission system according to at least one embodiment of the systems disclosed herein;

FIG. 2 is a side view of a variable drive transmission system according to at least one embodiment of the systems disclosed herein;

FIG. 3 is a side view of a pair of variable drive sprocket according to at least one embodiment of the sprockets disclosed herein;

FIG. 4 is a side view of a variable drive transmission on a bicycle according to at least one other embodiment of the sprockets disclosed herein; and

FIG. 5 is a side view of a variable drive transmission on a motor driven fan according to at least one other embodiment of the sprockets disclosed herein.

### DETAILED DESCRIPTION OF THE INVENTION

The present application generally provides a variable drive system with torque damping and/or torque multiplying characteristics. The system can be used as a transmission system for any type of device, including without limitation devices driven by motors, such as electric, hydraulic, steam, diesel, gas, etc, motors. For example, the transmission may couple motors to driven devices, such as fans for lawn motors, HVAC systems, drums for washing machines, dryers, etc., generators, compressors, etc. The system may even be used in human powered vehicles, such as bicycles. Accordingly, although the system may be described in relation to specific applications, the system is not limited to those specific applications discussed herein.

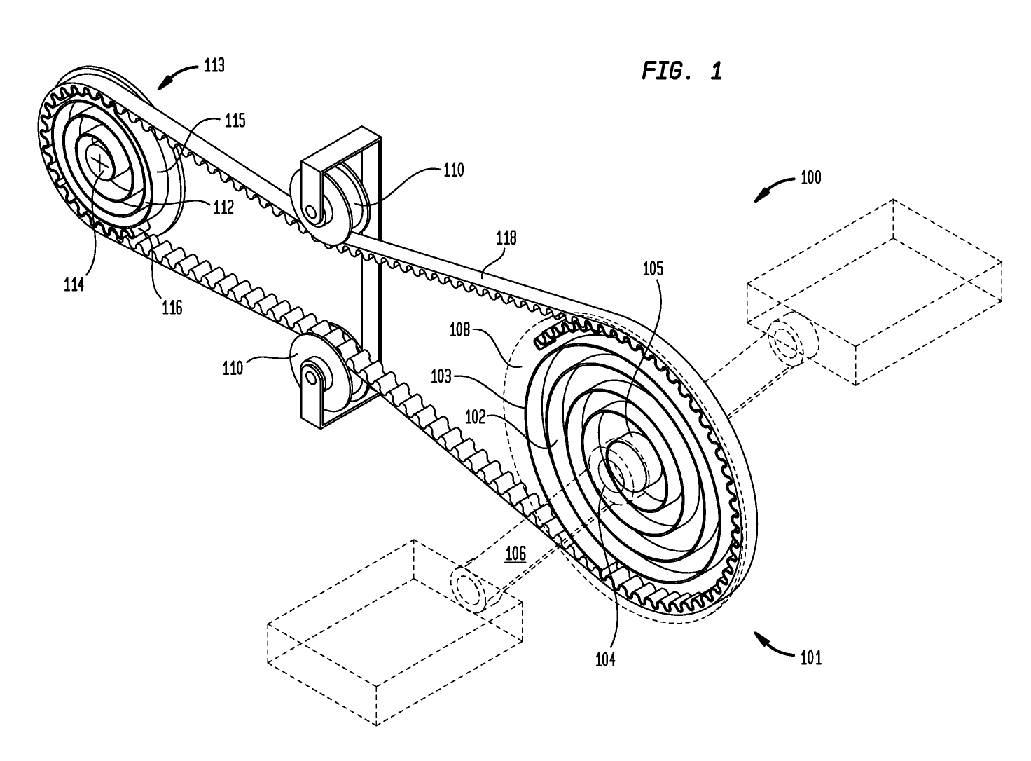

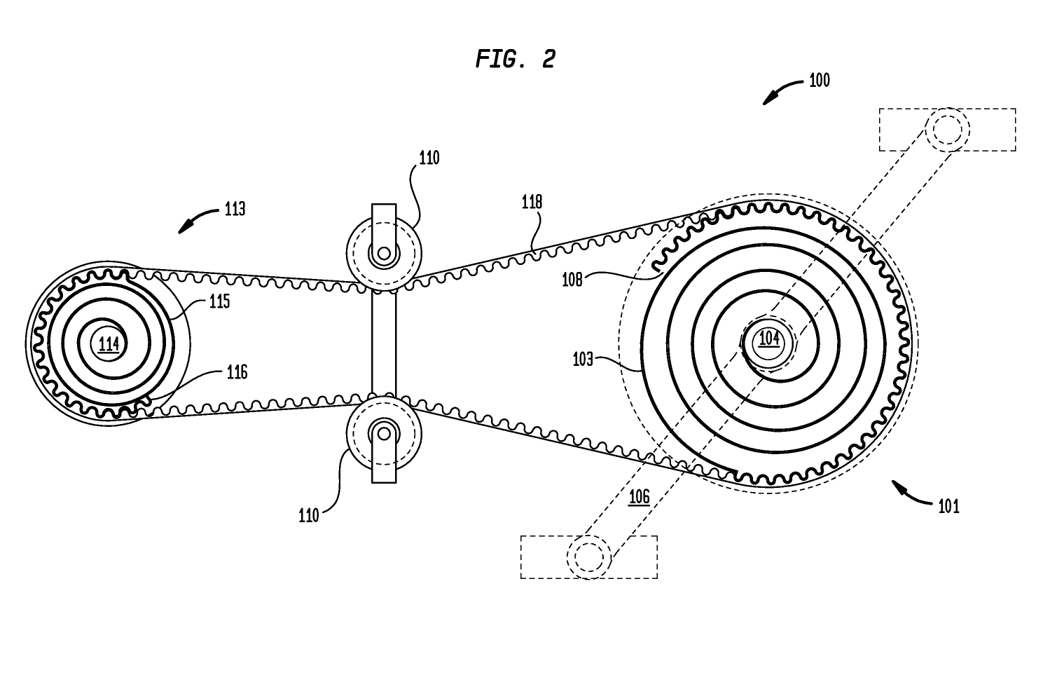

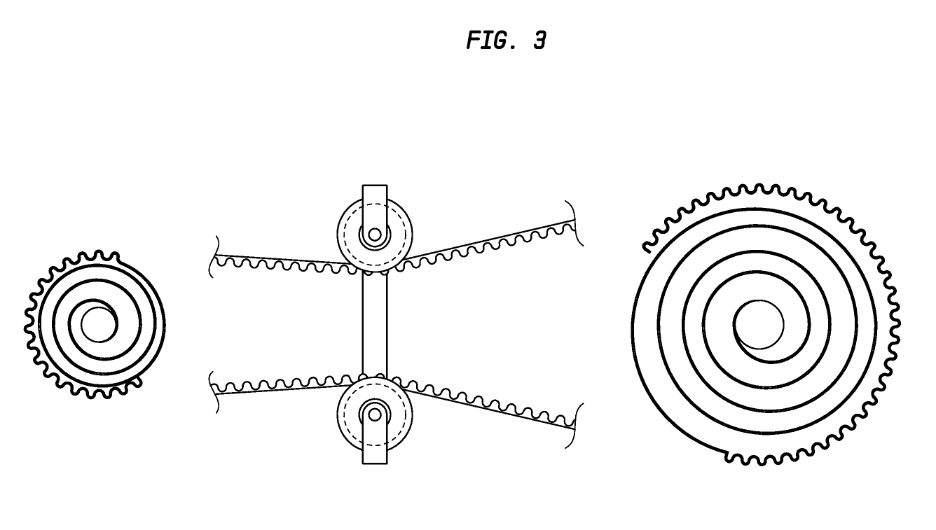

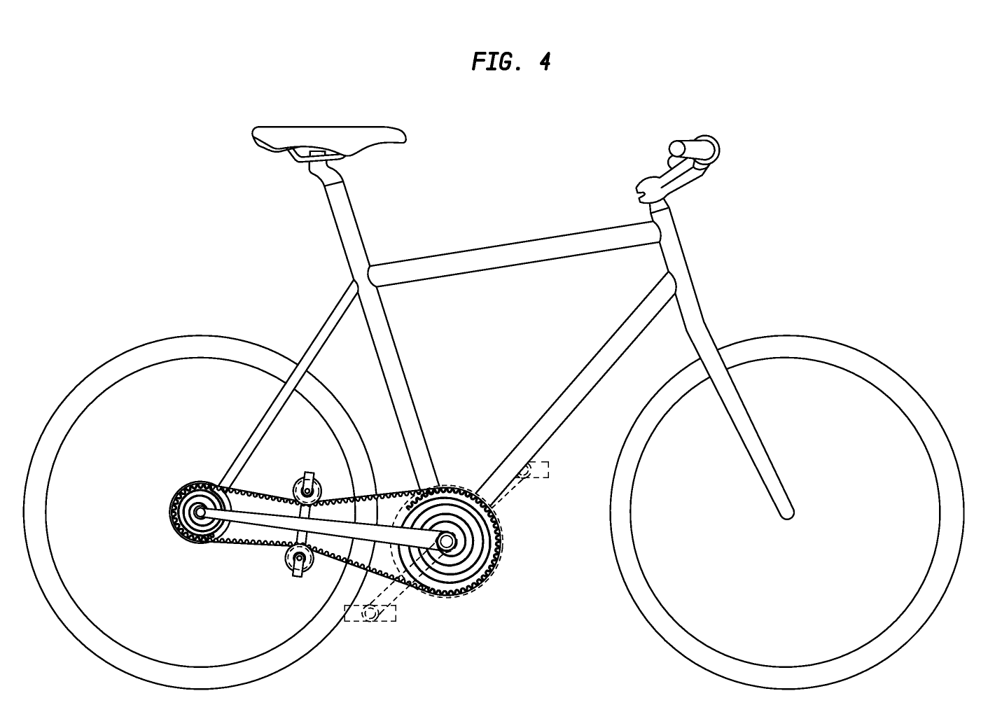

Referring to FIGS. 1-3, the transmission system 100 includes at least one variable diameter gear 101. The variable diameter gear 101 generally includes or is otherwise attached to a drive shaft 104. The drive shaft 104 is generally the component that provides the driving force at the counterpoint of the gear 101. For example, the shaft 104 may be the crankshaft of a gas powered engine or the axle of an electrically powered engine. Similarly, the shaft 104 may be the outwardly extending shaft of a bottom bracket for a bicycle, as shown in FIG. 4. In this or any other instance, the distal end of the shaft 104 may have a shape, such as a tapered square shape, to receive a similarly shaped hub 105 of the gear 101. In this regard, the gear 101 is preferably removably coupled or otherwise attached to the shaft 104. The hub 105 may further be attached to a proximal end of a crank 106.

The gear 101 preferably includes a spiral spring component 103 that is attached to and extends outward from the hub 105. The spring component 103 is coiled spirally in a direction, e.g., clockwise or counterclockwise, and the spring includes a certain number of active coils encircling the hub 105. The direction, the number of coils, the number of coils per inch, the dimensions of each coil, etc., will generally vary depending on the desired response from spring component 103. For example, a spring wound in a counterclockwise direction will tend to wind inward with a clockwise driving force at the shaft, which results in a decrease in the diameter of the gear 101. Similarly, a spring wound in a clockwise direction will tend to unwind with a counterclockwise driving force at the crank, which results in an increase in the diameter of the gear 101. The gear 101 includes an opened end 108 that allows the circumference of the gear to decrease and increase as the diameter of the gear varies.

The transmission may include a second variable diameter gear 113. The second gear 113 includes a hub 114 and a spiral spring component 115 that extends outward from the hub 114. The spring component 115 is coiled in a direction, e.g., clockwise or counterclockwise, and it includes a certain number of active coils encircling the hub 105. The direction, the number of coils, the number of coils per inch, the dimensions of each coil, etc., will generally vary depending on the desired response from spring component 115. In one embodiment, the direction of the coil of the second gear 113 is opposite the direction of the coil of the first gear 101. Alternatively, the direction of the coil of the second gear 113 is the same as the direction of the coil of the first gear 101. The second gear similarly includes an opening 116 that allows the diameter and the circumference of the gear 113 to vary.

The two gears 101, 113 are coupled to each other with a belt 118. The belt 118 tension may be maintained with one or more belt tensioners 110. The tensioners 110 generally take up any slack in the belt as the diameter of the gears 101, 113 varies in operation. The tensioners 110 also maintain a minimum tension about the gears 101, 113, to keep the belt from slipping as force is applied to the gears. The tensioners 110 may be attached to each other in a single unit with a spring that causes the individual tensioners to come together to provide a pinching force to the belt 118 as shown. Alternatively, one or more of the tensioners may be fixed to a frame associated with the device that the transmission system is being used in. For example, the tensioner may be attached to the frame of a bicycle, the base or the casing of an electric motor, etc.

The belt 118 rides on the outer surfaces 102, 112 of the gears 101, 113 and causes the driven gear 113 to rotate as a result of the driving force on the driving gear 101. It is understood that the relationship between the belt 118 and the surfaces 102, 112 may vary. For example, the belt 118 may rely primarily on friction to transfer the rotational movement from one gear to another. In this instance, the belt tension and/or the coefficient of friction between the belt 118 and the outer surfaces 102 may be tailored for the desired response. That is, tension may be minimized to limit wear on the bearings of the motors and rotational resistance, while maximizing the coefficient of friction to prevent slipping. Alternatively or additionally, the belt may include teeth that act against corresponding teeth on the outer surfaces 102, 112 of the gears 101, 113. In this instance, the gears preferably have at least a portion of the outer surface without teeth to allow the ends of the spring component at the open ends 108, 116 to move freely about the circumference of the gear. For example, uniformly spaced teeth may begin above the surfaces 102, 112 at the end of the spring component openings 108, 116 and continue for 10%, 20%, 30%, 40%, 50%, 60%, 70%, 80%, etc. of the circumference of the gear, as shown in FIGS. 1-3. The teeth may also be disposed in different sections of the outer surfaces 102, 112 with gaps in between the sections of teeth. For example, sections of uniformly spaced teeth may be disposed on the gear at half, thirds, quarters, etc. of the circumference of the gear. Although the transmission system is described herein by way of example using a belt, it is understood that other similar devices may be used, such as a chain. When using a chain, one or more of the gears 101, 103, may include teeth thereon that are received in corresponding holes in the chain. Conversely, the chain may have teeth that are received by corresponding holes in the spring.

As noted above, the spring variables may be designed for a specific response. For example, the springs may be designed for a specific bicycle rider or for specific riding conditions. For instance, softer springs may be used for lighter riders and for hilly terrain. This will allow the gears to vary in diameter more easily for these specific conditions. Similarly, heavier springs may be used for heavier riders and flat terrain. This allows the gears to vary in diameter much less for these specific conditions. The springs may also be sold in kits that have springs therein with different spring rates, which riders may swap out as needed. The lighter and heavier characteristics may be achieved with thinner or thicker coils, more or less coils, more or less coils per inch, different materials, etc. The springs may have variable characteristics as well. That is, the springs may have sections with thicker coils than other sections or sections with more coils per inch than other sections.

In operation, a driving force is applied to the shaft 104. For example, a bicycle rider may apply force to the crank to cause the bicycle to accelerate. This force, applied in a clockwise direction via the shaft 104, will cause the spring component 103 of the driving gear 101 to wind into itself. This results in a reduction in the diameter of the gear 101 which increases the leverage that the rider has to accelerate the bicycle, thereby making pedaling easier. The force is thereafter transferred via belt 118 to the driven gear 113, which appears as a clockwise force at the hub 114 of the driven gear 113. This results in the unwinding of the spring component 115 of the driven gear 113, which further increases the leverage that the rider has to accelerate the bicycle.

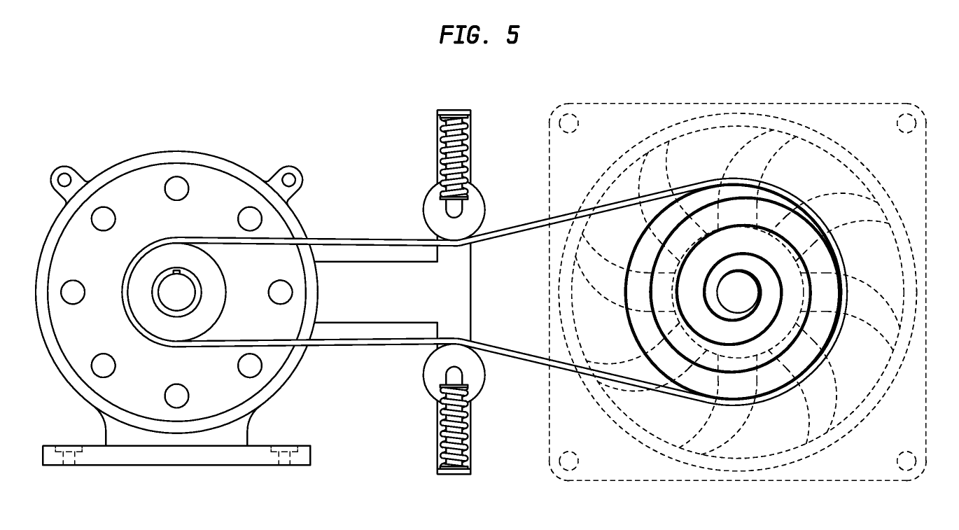

The winding of the spring component 103 and unwinding of the spring component 115 beneficially absorb shock and store energy that is later released preferably to drive the rear gear. That is, the springs providing an evening affect that softens the pulse that would otherwise be felt from a force applied to the gear. That energy is stored in the spring component and it is released as the force of the gear is released. This applies to all rotational forces applied to gears 101, 113, regardless of whether the forces cause the gear to accelerate from a stopped position or whether the forces cause the gear to accelerate or decelerate. Although discussed with relation to bicycles, the transmission system may be used to assist any driving motor. For example, the transmission may be used to drive commercial cooling fans, as shown in FIG. 5. In this instance, the motor will have more leverage to accelerate the fan from a stopped position, which reduces the load on the motor controller and/or motor starter. In automotive uses, the transmission system may reduce the impact on the car's motor, transmission, clutch, air conditioning, generator, alternator, drive axles, etc. as components, such as the air conditioner, are turned on and off.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A variable drive transmission system comprising:
a first variable diameter gear coupled to a drive shaft at a hub of the first variable diameter gear, the drive shaft provides a driving force that causes rotational movement in the first variable diameter gear, wherein the first variable diameter gear comprises a spiral spring component that extends out of the hub of the first gear, coils spirally in a direction around the hub, and terminates openly on an outer surface of the variable diameter gear; and wherein application of the driving force at the hub causes the spiral spring component to one of wind and unwind, and as a result increase or decrease the diameter of the first variable diameter gear;
a second gear having an outer surface;
a continuous belt that is located over the outer surfaces of the first and the second gears and that is held in tension over the outer surfaces of the gears to transfer rotational movement from first gear to the second gear; and
a tensioner that applies a force onto the continuous belt to maintain the belt tension.

2. The transmission system of claim 1, wherein the direction of the spiral spring is one of clockwise and counter clockwise.

3. The transmission system of claim 1, wherein the second gear is a variable diameter gear coupled to a drive shaft at a hub of the second variable diameter gear and the second gear comprises a spiral spring component that extends out of the hub of the second gear, coils spirally in a direction around the hub, and terminates openly on an outer surface of the variable diameter gear; and wherein application of the driving force causes the spiral spring component to one of wind and unwind, and as a result increase or decrease the diameter of the second variable diameter gear.

4. The transmission system of claim 3, wherein the spring of the first gear is wound in a first direction and the spring of the second gear is wound in a second direction opposite the first direction, and wherein the application of a driving force causes one of the gears to increase in diameter and another gear to decrease in diameter.

5. The transmission system of claim 4, wherein the first direction of the spring in the first gear causes the diameter of the first gear to decrease with the application of the driving force on the first gear and the second direction of the spring in the second gear causes the diameter of the second gear to increase with the application of the driving force on the second gear.

6. The transmission system of claim 1, wherein the first variable diameter gear comprises teeth that engage corresponding teeth on the belt.

7. The transmission system of claim 6, wherein the teeth start at the opening on the outer surface of the first variable diameter gear and continue around less than all of the circumference of the outer surface of the first variable diameter belt.

8. The transmission system of claim 1, wherein the spring has a response characteristic tailored to one of a specific rider type and a specific riding condition.

9. The transmission system of claim 8, wherein a spring for a heavier rider has a response characteristic different than a spring for a lighter rider.

10. The transmission system of claim 1, wherein the spring has at least one variable characteristic to provide a variable response.

11. A variable drive transmission system comprising:
a first variable diameter gear coupled to a drive shaft at a hub of the first variable diameter gear, the drive shaft provides a driving force that causes rotational moment in the first variable diameter gear, wherein the first variable diameter gear comprises a spiral spring component that extends out of the hub of the first gear, coils spirally in a first direction around the hub, and terminates openly on an outer surface of the variable diameter gear; and wherein application of the driving force at the hub causes the spiral spring component to one of wind and unwind, and as a result increase or decrease the diameter of the first variable diameter gear;
a second variable diameter gear coupled to a drive shaft at a hub of the second variable diameter gear and a spiral spring component that extends out of the hub of the second gear, coils spirally in a second direction around the hub, and terminates openly on an outer surface of the second variable diameter gear, and wherein application of the driving force causes the spiral spring component to one of wind and unwind, and as a result increase or decrease the diameter of the second variable diameter gear;
a continuous belt that is located over the outer surfaces of the first and the second gears and that is held in tension over the outer surfaces of the gears to transfer rotational movement from first gear to the second gear; and
a tensioner that applies a force onto the continuous belt to maintain the belt tension.

12. The transmission system of claim 11, wherein the direction of one of the spiral springs is clockwise and the direction of the other of the spiral springs is counter clockwise.

13. The transmission system of claim 12, wherein the spring of the first gear is wound in a first direction and the spring of the second gear is wound in a second direction opposite the first direction, and wherein the application of a driving force causes one of the gears to increase in diameter and another gear to decrease in diameter.

14. The transmission system of claim 13, wherein the first direction of the spring in the first gear causes the diameter of the first gear to decrease with the application of the driving force on the first gear and the second direction of the spring in the second gear causes the diameter of the second gear to increase with the application of the driving force on the second gear.

15. The transmission system of claim 11, wherein at least one of the first variable diameter gear and the second variable diameter comprises teeth that engage corresponding teeth on the belt.

16. The transmission system of claim 15, wherein the teeth start at the opening on the outer surface of the at least one of the first variable diameter gear and the second variable diameter gear and continue around less than all of the circumference of the outer surface of the at least one of the first variable diameter gear and the second variable diameter gear.
